(19) United States
(12) Patent Application Publication
(10) Pub. No.: US 2024/0120523 A1
(43) Pub. Date: Apr. 11, 2024

(54) METHOD OF MANUFACTURING AN ELECTROCHEMICAL ENERGY STORAGE ELEMENT

(71) Applicant: VARTA Microbattery GmbH, Ellwangen Jagst (DE)

(72) Inventors: Martin Elmer, Ellwangen (DE); Martin Fürst, Rainau-Schwabsberg (DE)

(21) Appl. No.: 18/279,335

(22) PCT Filed: Feb. 11, 2022
(86) PCT No.: PCT/EP2022/053307

§ 371 Date: Aug. 29, 2023

(30) Foreign Application Priority Data
Mar. 3, 2021 (EP) 21160487.1

(51) Int. Cl. H01M 10/04; H01M 10/0525; H01M 10/0587; H01M 50/103; H01M 50/107; H01M 50/119

(52) U.S. Cl. CPC H01M 10/0431; H01M 10/049; H01M 10/0525; H01M 10/0587; H01M 50/103; H01M 50/107; H01M 50/119

(57) ABSTRACT

A method of manufacturing an electrochemical energy storage element, the energy storage element includes a housing having at least one metallic housing part and an electrode-separator assembly disposed inside the housing, the method including: a. providing the metallic housing part and the electrode-separator assembly, b. heating the metallic housing part to cause expansion of the housing part, c. inserting the electrode-separator assembly into the expanded metallic housing part, and d. closing the metallic housing part to form the housing.

### TECHNICAL FIELD

This disclosure relates to a method of manufacturing an electrochemical energy storage element and to an electrochemical energy storage element manufactured according to the method.

### BACKGROUND

Electrochemical energy storage elements are capable of converting stored chemical energy into electrical energy by a redox reaction. They usually comprise at least one energy storage cell with a positive and a negative electrode separated by a separator. During a discharge, electrons are released at the negative electrode by an oxidation process. This results in an electron current that can be tapped by an external electrical load, for which the at least one electrochemical energy storage cell serves as an energy supplier. At the same time, an ion current corresponding to the electrode reaction occurs within the cell. This ion current passes through the separator and is enabled by an ion-conducting electrolyte. If the discharge is reversible, i.e., it is possible to reverse the conversion of chemical energy into electrical energy that occurred during the discharge and thus recharge the cell, the cell is said to be a secondary cell. The designation of the negative electrode as anode and the designation of the positive electrode as cathode, which is generally used for secondary cells, refers to the discharge function of the electrochemical cell.

Secondary lithium-ion cells are used for many applications today because they can provide high currents and are characterized by a comparatively high energy density. They are based on the use of lithium, which can move back and forth between the electrodes of the cell in the form of ions. For applications in the automotive sector, e-bikes or also other applications with high energy requirements such as in tools, secondary lithium-ion cells with the highest possible energy density are needed, which at the same time are capable of being loaded with high currents during charging and discharging.

The negative electrode and the positive electrode in energy storage cells are often so-called composite electrodes, which include electrochemically active components as well as electrochemically inactive components. The composite electrodes are usually combined with one or more separators to form an assembly. To obtain the assembly, the electrodes and separators are usually bonded together under pressure, possibly also by lamination or bonding. The basic func-tionality of the cell can then be established by impregnating the assembly with an electrolyte.

Alternatively, a solid-state electrolyte can be used instead of a separator soaked with an electrolyte.

In many configurations, the assembly is produced in the form of a winding or transformed into a winding. Generally, it has the sequence positive electrode/separator/negative electrode. Often, assemblies are produced as so-called bi-cells with the possible sequences negative electrode/separator/positive electrode/separator/negative electrode or positive electrode/separator/negative electrode/separator/positive electrode.

Energy storage cells are often designed as cylindrical round cells whose housing is characterized by a circular or, if necessary, oval base and a cylindrical shell. Energy storage cells of this type usually comprise an electrode-separator assembly in the form of a winding. To form an energy storage cell with a cylindrical base shape, band-shaped electrodes and separators can be processed in a winding machine to form a spiral-shaped winding. Such a winding fits perfectly into a cylindrical housing.

A common form factor for cylindrical round cells, for example, is the 21×70 form factor (diameter×height in mm). Modern lithium-ion cells of this form factor can, for example, achieve an energy density of up to 270 Wh/kg.

Besides such cylindrical round cells, whose height is generally greater than their diameter, cylindrical button cells are widely used, especially for powering small electronic devices such as hearing aids or wireless headphones, and are generally characterized by a height that is less than their diameter.

WO 2017/215900 A1 describes energy storage cells in which the electrodes and the electrode-separator assembly are strip-shaped and in the form of a winding. The electrodes each have current collectors loaded with electrode material. Oppositely poled electrodes are arranged offset to each other within the electrode-separator assembly so that longitudinal edges of the current collectors of the positive electrodes emerge from the winding on one side and longitudinal edges of the current collectors of the negative electrodes emerge on the opposite side. For electrical contacting of the current collectors, the cell has at least one contact element which rests on one of the longitudinal edges. The contact element is connected to the longitudinal edge by welding. This makes it possible to electrically contact the current collector and thus also the associated electrode over its entire length. This reduces the internal resistance within the described cell very significantly. The occurrence of large currents can subsequently be absorbed much better.

In other configurations, energy storage elements may comprise a prismatic assembly of stacked electrodes. The housing of such energy storage elements is characterized by a polygonal and in particular a rectangular base. In such a configuration, electrodes with a polygonal base are stacked such that a prismatic assembly is formed. Within the stack, oppositely poled electrodes are usually separated from each other by separators or layers of a solid-state electrolyte so that there is no direct contact between the oppositely poled electrodes. For example, a prismatic or cubic assembly formed from rectangular stacks of electrodes fits perfectly into a corresponding prismatic or cubic housing. Within the housing, the electrodes of the stack can be electrically interconnected. Typically, electrodes with the same polarity are coupled within the housing to a common current conductor, which is either electrically connected to one of the housing parts or is led out of the housing via a corresponding aperture.

Electrochemical energy storage elements often have a metallic housing. In the manufacture of energy storage elements, the electrode-separator assembly in the form of the winding or stack described must in such configurations be inserted into a cylindrical or prismatic metallic housing, which is then sealed. These operations are usually carried out in an automated manner as part of industrial manufacturing processes.

There is thus a need to provide energy storage elements with a very high energy density.

### SUMMARY

We provide a method of manufacturing an electrochemical energy storage element, the energy storage element including a housing having at least one metallic housing part and an electrode-separator assembly disposed inside the housing, the method including: a. providing the metallic housing part and the electrode-separator assembly; b. heating the metallic housing part to cause expansion of the housing part; c. inserting the electrode-separator assembly into the expanded metallic housing part; and d. closing the metallic housing part to form the housing.

We also provide an electrochemical energy storage element including a housing having at least one metallic housing part and an electrode-separator assembly disposed within the housing, wherein the electrochemical energy storage element is manufactured by the method of manufacturing an electrochemical energy storage element, the energy storage element including a housing having at least one metallic housing part and an electrode-separator assembly disposed inside the housing, the method including: a. providing the metallic housing part and the electrode-separator assembly; b. heating the metallic housing part to cause expansion of the housing part; c. inserting the electrode-separator assembly into the expanded metallic housing part; and d. closing the metallic housing part to form the housing.

### BRIEF DESCRIPTION OF THE DRAWINGS

FIG. 1 is a schematic longitudinal sectional view of an exemplary cylindrical round cell.

FIG. 2 is a schematic representation of the various steps in the manufacture of a cylindrical round cell (steps A-I), each in longitudinal section.

### DETAILED DESCRIPTION

Our method is used to manufacture an electrochemical energy storage element, the energy storage element having a housing with at least one metallic housing part and an electrode-separator assembly arranged inside the housing. The manufacturing process comprises the following process steps:
a. The metallic housing part and the electrode-separator assembly are provided,
b. the metallic housing part is heated to cause expansion of the housing part,
c. the electrode-separator assembly is inserted into the expanded metallic housing part, and
d. the metal housing part is closed to form the housing.

The metallic housing part encloses an interior space into which the electrode-separator assembly can be inserted. In cylindrical round cells or button cells, the housing part is preferably hollow cylindrical, in particular cup-shaped. In prismatic energy storage elements, the metallic housing part is preferably prismatic. Depending on the shape of the energy storage element to be manufactured, the metallic housing part can accordingly have a round or oval or a polygonal, in particular rectangular, base.

In cylindrical round cells, the housing part preferably comprises a circumferential housing shell with a round or oval cross-section, and particularly preferably a bottom with the round or oval base. In prismatic cells, the housing part preferably comprises n side parts, where n corresponds to the number of angles of the base and each side part is connected to a first adjacent side part via a common angle and to a second adjacent side part via a further common angle. The side parts are preferably rectangular in shape. Particularly preferably, in a prismatic energy storage element, the housing part comprises a bottom with the polygonal, in particular rectangular, base.

The housing part comprises at least one opening through which the electrode-separator assembly can be inserted, in particular pushed, into the metallic housing part. In a cylindrical cell, this opening is circular or oval and defined by an edge of the housing shell. In a prismatic energy storage element, this opening has a polygonal form like the base and is defined by edges of the side parts. Size and shape of the opening limit the size and shape of the electrode-separator assembly to be inserted.

The dimensions and shape of the metallic housing part and the electrode-separator assembly are suitably matched to each other to make the best possible use of the volume of the interior space. If the electrode-separator assembly is cylindrical, the metallic housing part is therefore preferably hollow cylindrical to be able to perfectly enclose the cylindrical electrode-separator assembly. If the electrode-separator assembly has a prismatic or cuboid shape, the metallic housing part is prismatic or cuboid-shaped accordingly.

Heating in accordance with the process causes the material of the metallic housing part to expand (thermal expansion), with the opening of the metallic housing part widening and the volume of the interior space enclosed by the housing part increasing. On the one hand, this simplifies insertion of the electrode-separator assembly into the housing part since more space is available. On the other hand, this enables the available space inside the metallic housing part to be better utilized since a larger electrode-separator assembly can be introduced than would be possible using conventional methods, i.e., without heating the housing part. An electrode-separator assembly, for example, a cylindrical winding, with a larger diameter than conventional methods can therefore be introduced. This allows more electrochemical active material to be introduced into the energy storage element, resulting in a gain in capacity and a greater energy density of the energy storage element. Overall, the method makes it possible to dispense with the free space between the electrode-separator assembly and the housing provided in conventionally manufactured energy storage elements, which is required for problem-free insertion of the electrode-separator assembly into the housing during manufacture.

A further particular advantage of the process is that moisture can be removed from the housing part and in particular from the interior of the housing part by heating the metallic housing part. Any moisture present in the interior of the housing can have negative effects on cell performance. Such negative effects of moisture are prevented or at least minimized by the manufacturing process in the manufactured energy storage elements.

During charging and discharging processes, the electrodes of electrochemical energy storage elements can be subject to volume fluctuations. This can be a problem, particularly in lithium-ion cells, since the volume fluctuations are accompanied by mechanical stress on the electrodes and can reduce the service life of the energy storage cells. This problem is also counteracted by our approach. By controlling the volume utilization of the interior of the housing part in accordance with our method, it is achieved that a counterpressure is exerted on the expanding electrodes by the housing so that the electrodes are better braced, which reduces their mechanical stress during the charging process.

In addition, the controlled use of volume in energy storage elements manufactured can also prevent vibrations of the electrode-separator assembly within the housing. Depending on the area of application, for example, in power tools, vibrations occurring in conventionally manufactured energy storage elements can cause considerable stress. This vibration load can be significantly reduced in energy storage elements manufactured according to our method since the available interior space is fully utilized. In this respect, too, an increase in the service life of the energy storage elements manufactured according to our method can be achieved.

The heating of the metallic housing part can easily be implemented in automated form so that the process can be implemented very well in industrial production processes.

In a particularly preferred manner, heating of the metallic housing part prior to insertion of the electrode-separator assembly can be implemented as part of the process in the following manner:
a. The heating of the metallic housing part is performed by an input of electrical energy, in particular by an input of inductive and/or ohmic energy.

By applying electrical energy in accordance with the aforementioned feature a., heating of the metallic housing part can be achieved very quickly and in a very targeted manner.

During inductive energy input or inductive heating, a coil through which alternating current flows, the inductor, generates an alternating magnetic field which induces eddy currents in the metal housing part. The eddy current losses generated cause the metallic housing part to heat up. Since the heat is generated in the housing part itself, there is no need for transmission by thermal conduction. The heat output can be controlled very well so that this process for heating the metal housing part is also very suitable, particularly with regard to automation of the process.

In particular, it is possible to use an inductive energy input to heat the housing part more strongly in one area than in another area. In a cup-shaped housing part, for example, it may be desirable to heat the edge of the opening more strongly than the outer edge.

During the input of ohmic energy, an electric current is passed through the metallic housing part, whereby electrical energy is converted into thermal energy and the housing part is heated in the process. Preferably, an electrical voltage is applied to the housing part via two or more electrodes that come into direct contact with the housing part. This process can also be controlled very well and used in a targeted manner so that it is also very suitable, particularly with regard to automation of the process.

Particularly preferably, the method is characterized by at least one of:
a. Heating of the metallic housing part includes a high-temperature phase, and
b. in the high-temperature phase, the metallic housing part is heated at least in some areas to a temperature of 80 to 150° C., preferably 90 to 110° C., particularly preferably 95 to 105° C.

In the high-temperature phase, the metallic housing part is preferably heated to a temperature of 80 to 150° C. Particularly preferably, the temperature is 90 to 110° C., in particular 95 to 105° C. It may be envisaged that this temperature is possibly reached only in one section or in one area of the entire housing part. It is important that the opening of the housing part is covered by the heating.

It is advisable for the temperature of the high-temperature phase to be below the melting point of the separator used in the electrode-separator assembly. With this specification, thermal damage to the electrode-separator assembly is reliably avoided. On the other hand, the temperature of the high-temperature phase should be high enough to achieve an expansion of the opening width of the metallic housing part.

The duration of the high-temperature phase can be relatively short. Usually, a few seconds or even fractions of a second are sufficient for this high-heating of the metallic housing part to achieve the desired expansion.

Particularly preferably, the method is characterized by at least one of:
a. Heating of the metallic housing part includes a preheating phase, and
b. in the preheating phase, the metallic housing part is heated to a temperature of 35 to 80° C., preferably 40 to 70° C., particularly preferred 50 to 60° C.

The preheating phase usually takes place before the high-temperature phase and is preferably used for relatively slow preheating of the metallic housing part. The preheating phase avoids sudden large temperature jumps in the material of the housing part so that material damage does not occur due to sudden temperature changes. Preferably, in the preheating phase the metallic housing is heated to a temperature of 35 to 80° C., preferably 40 to 70° C., and particularly preferably 50 to 60° C. In principle, only part of the metallic housing part can also be heated accordingly in this phase, as in the high-temperature phase. In general, however, it is preferred, particularly in the preheating phase, that the entire metallic housing part be heated to avoid material stresses. Due to the lower temperatures compared with the high-temperature phase, uniform heating of the metallic housing part in the preheating phase is easily possible even in a short period of time so that complete preheating of the metallic housing part does not prevent a fast, automated process.

In particularly preferred examples of the process, the preheating phase is followed immediately by the high-temperature phase. It is preferred that in the high-temperature phase the housing part is brought to the required temperature only for a very short time, i.e., for only a few seconds (1 to 10 s) or possibly less than a second.

Particularly preferably, an input of electrical energy is provided for the high-temperature phase to heat the metallic housing part, in particular an input of inductive and/or an ohmic energy. With these methods, the high-temperature phase can be carried out very quickly and in a targeted manner. For the technical implementation, the aforementioned electrodes in particular can be applied to the metallic housing part and supplied with current so that the targeted heating can be carried out by ohmic energy input within a very short time.

Preferably, the preheating phase is carried out using waste heat to enable a particularly economically advantageous process.

Particularly preferably, the method is characterized by at least one of:
a. The metallic housing part is cooled after inserting the electrode-separator assembly, and
b. the metallic part of the housing is cooled before closing the housing.

After the electrode-separator assembly has been introduced into the metallic housing part, the housing part generally cools very quickly and shrinks back to the original extent of the metallic housing part. It is therefore possible to introduce a larger electrode-separator assembly into the interior of the housing part than is possible with conventional processes. The volume of the interior of the housing part can thus be fully utilized.

The step of cooling the housing part can be designed passively. In the simplest example, one simply waits until the housing part reaches room temperature again. However, for production reasons in particular, it may be desirable to actively support the cooling process, for example, to enable the electrode-separator assembly to be impregnated with a volatile electrolyte. This can be supported by a cooling fan, for example.

The material of the metallic housing part can be, for example, nickel-plated steel or stainless steel, which can also be nickel-plated if necessary, or material coated on one or both sides with aluminum. Particularly preferably, the housing is made of a steel, in particular a stainless steel, and has an inner side which is coated with aluminum at least in certain areas. An external coating with nickel or another corrosion-resistant material is optional. In further possible examples, the materials may be composites of different metallic materials, for example, so-called trimetals, for example, a composite of copper, stainless steel and nickel. Furthermore, material pairings with aluminum can be advantageous.

Particularly preferably, the metallic material of the housing part is controlled with regard to its thermal expansion properties. In this way, controlled expansion of the housing part can be achieved by heating in the course of the manufacturing process.

In a further preferred example of our method, the method is characterized by:
a. Before inserting the electrode-separator assembly into the metallic housing part, the electrode-separator assembly is cooled.

By cooling the electrode-separator assembly before inserting it into the metallic housing part, a certain shrinkage of the electrode-separator assembly can be achieved. This, in combination with the heating and thermal expansion of the metallic housing part, can further facilitate the insertion of the electrode-separator assembly into the housing part and, if necessary, allow further enlargement of the electrode-separator assembly compared with conventional manufacturing processes. In general, the specific heat capacity of the electrode-separator assembly is greater than that of the metallic housing part so cooling the electrode-separator assembly is somewhat less effective than heating the metallic housing part. Nevertheless, this cooling phase may allow further advantages or further improvement of the process. In this context, it may be further advantageous if the starting materials for the production of the electrode-separator assembly are also already cooled. For example, it can be provided that the electrodes are already cooled when they are introduced into an automatic winding machine during the production of an electrode-separator assembly in the form of a winding.

Particularly preferably, the method is characterized by at least one of:
a. At least the heating of the metallic housing part is carried out under dehumidifying conditions,
b. at least the insertion of the electrode-separator assembly into the metallic housing part is carried out under dehumidifying conditions,
c. at least the heating of the metallic housing part is carried out under negative pressure conditions, and
d. at least the insertion of the electrode-separator assembly into the metallic housing part is carried out under negative pressure conditions.

Particularly preferably, the aforementioned a. and c., in particular a. and c. and d., and particularly preferably a. to d. are combined.

The dehumidifying conditions during heating according to the above-mentioned a. and/or during insertion of the electrode-separator assembly into the housing part according to the above-mentioned b. can prevent negative moisture effects on cell performance in a particularly effective manner. The dehumidifying conditions can be realized, for example, by production of the energy storage cells being carried out in clean and/or dry rooms, as is generally already often true in industrial manufacturing processes anyway. It is also possible to introduce air with a lower dew point in a targeted manner. If necessary, vacuum drying can additionally be carried out, for example. Preferably, the conditions are set so that the residual moisture is below 300 ppm, especially preferably below 100 ppm. Suitable ambient conditions in a drying room are, for example, 1±0.5% relative humidity.

Alternatively or additionally, negative pressure conditions can be provided during heating according to the aforementioned c. and/or during insertion of the electrode-separator assembly into the metallic housing part according to the aforementioned d. On the one hand, the negative pressure conditions support the dehumidification. On the other hand, negative pressure conditions can facilitate the insertion of the electrode-separator assembly into the housing part. When the process is carried out at ambient pressure, the air contained inside the housing part may exert a counterpressure when the electrode-separator assembly is inserted, or the air present in the housing part may not be able to escape quickly enough. This is avoided by the negative pressure conditions. This has the particular advantage that the process speed can also be further increased. In advantageous examples, the pressure can be 1 mbar-800 mbar, for example, preferably 10 mbar to 500 mbar.

It is particularly preferred if the heating of the metal housing part is combined with drying, the drying being supported in particular by the addition of dry air and/or the use of a vacuum or negative pressure. A vacuum in this context means that a pressure below ambient pressure is set, in particular 800 mbar or less, preferably 500 mbar or less.

Closing the housing and contacting the electrodes with the housing can be done in a manner known per se, comparable to conventional processes. For example, the opening of a cup-shaped housing part can be closed by a flanging process using an electrically insulating seal, or the opening can be closed by welding in a cover.

The process is suitable both for the production of cylindrical energy storage elements and prismatic energy storage elements. Accordingly, the housing of the energy storage element can be a cylindrical housing or a prismatic housing.

Particularly preferably, the process is used to manufacture cylindrical round cells. Energy storage elements with a form factor of 21×70 (diameter×height in mm) are particularly preferred here. Of course, the process can also be used advantageously for the production of energy storage elements with a different form factor.

The electrode-separator assembly may be a cylindrical winding or a prismatic stack of electrodes. Particularly preferably, it is a cylindrical wound assembly as is commonly used in cylindrical round cells.

Particularly preferably, the method is characterized by:
a. The electrochemical energy storage element is a lithium-ion cell or comprises one or more lithium-ion cells.

In principle, all materials that can absorb and release lithium ions can be used as electrochemically active components (active materials) for lithium-ion cells. Carbon-based particles, especially graphitic carbon, are suitable for the negative electrode. Other non-graphitic carbon materials capable of intercalating lithium can also be used. In addition, metallic and semi-metallic materials that are alloyable with lithium can also be used. For example, the elements tin, aluminum, antimony and silicon are capable of forming intermetallic phases with lithium. For example, lithium cobalt oxide (LiCoO₂), lithium manganese oxide (LiMn₂O₄), lithium iron phosphate (LiFePO₄) or derivatives thereof can be used as active materials for the positive electrode. The electrochemically active materials can be contained in the electrodes, in particular in particle form.

The electrodes for lithium-ion cells are preferably built as composite electrodes which, in addition to the electrochemically active components, also comprise electrochemically inactive components. Furthermore, the composite electrodes preferably comprise a flat and/or strip-shaped current collector, for example, a metallic foil that serves as a carrier for the respective active material. The current collector for the negative electrode (anode current collector) can be formed, for example, from copper or nickel and the current collector for the positive electrode (cathode current collector) can be formed, for example, from aluminum. As electrochemically inactive components, the electrodes preferably comprise an electrode binder, for example, polyvinylidene fluoride (PVDF) or another polymer, for example, carboxymethyl cellulose as well as conductivity-improving additives and/or other additives. The electrode binder ensures the mechanical stability of the electrodes and often also the adhesion of the active material to the current collectors.

In particular, porous plastic films can be used as separators between the electrodes, for example, made of a polyolefin or a polyether ketone.

The most suitable electrolytes for lithium-ion cells are solutions of lithium salts such as lithium hexafluorophosphate (LiPF₆) in organic solvents (e.g., ethers and esters of carbonic acid).

We further provide an electrochemical energy storage element having a housing with at least one metallic housing part and an electrode-separator assembly arranged inside the housing. The electrochemical energy storage element is characterized in that it is manufactured by the method described above. With regard to further features of the energy storage element, reference is therefore also made to the above description.

In particular, the energy storage element is characterized by the fact that it realizes an controlled utilization of the volume of the housing, as a result of which the capacity of the energy storage element is increased compared to conventional energy storage elements and thus an controlled energy density is achieved. The controlled utilization of the interior of the housing minimizes the electrode expansion associated with the charging process in the electrode-separator assembly due to the counterpressure exerted by the housing, thereby reducing mechanical stress on the electrodes. Furthermore, vibration of the electrode-separator assembly within the housing is prevented or minimized by the controlled utilization of the interior space of the housing. At the same time, our manufacturing process reduces the residual moisture within the housing so that negative effects of moisture on cell performance are prevented.

Particularly preferably, the electrochemical energy storage element is characterized by:
a. The energy storage element is a cylindrical round cell with a cylindrical housing and with a winding as an electrode-separator assembly, and
b. with respect to the diameter of the cylindrical round cell, the energy storage element has a spatial utilization of the internal volume of the housing by the winding of more than 95%, preferably more than 99%, preferably 100%, without taking into account any central cavity of the winding which may be present.

Characterization of the energy storage cell with respect to the aforementioned b. relates in this example to the part or section of the cylindrical housing in which the winding rests against the inside of the housing directly or at a very small distance. Thus, this characterization of the energy storage cell does not relate to the portions of the energy storage cell that lie between the end faces of the winding and the end face portions of the cylindrical housing. Furthermore, in the spatial utilization of the internal volume of the housing by the winding defined in accordance with the aforementioned b., any central cavity of the winding which may be present and which may be partially or completely filled with a winding core is not taken into account. This means, therefore, that the aforementioned 95% or the preferred more than 99% or 100% refers exclusively to the space between the outer circumference of the winding and the inside of the housing.

Accordingly, the internal volume of the housing of the cylindrical round cell can be maximally utilized with respect to the diameter of the housing, thereby minimizing the dead volume of the round cell. By heating the metallic housing part during the manufacturing process, an electrode-separator assembly can be introduced into the interior of the housing part with an outer circumference corresponding to the inner circumference of the housing part at room temperature. The expansion of the opening of the housing part achieved by heating the housing part allows the electrode-separator assembly to be inserted with sufficient clearance during the manufacturing process. The subsequent cooling of the housing part causes the wall of the housing to contact the outer circumference of the electrode-separator assembly directly, i.e., without clearance so that maximum volume utilization is achieved. The enlarged electrode-separator assembly compared to conventional energy storage elements enables the capacity of the energy storage elements to be increased. At the same time, stabilization of the electrode-separator assembly is achieved to prevent distortion during electrode expansion and to avoid vibrations within the housing.

The spatial utilization of the internal volume of the housing, preferably 100% in relation to the cross-section, refers to the electrode-separator assembly in the uncharged state. Excessive expansion of the electrodes during the charging process is absorbed by the support of the housing.

Further features and advantages result from the following description of examples in connection with the drawings. The individual features can be realized individually or in combination with each other.

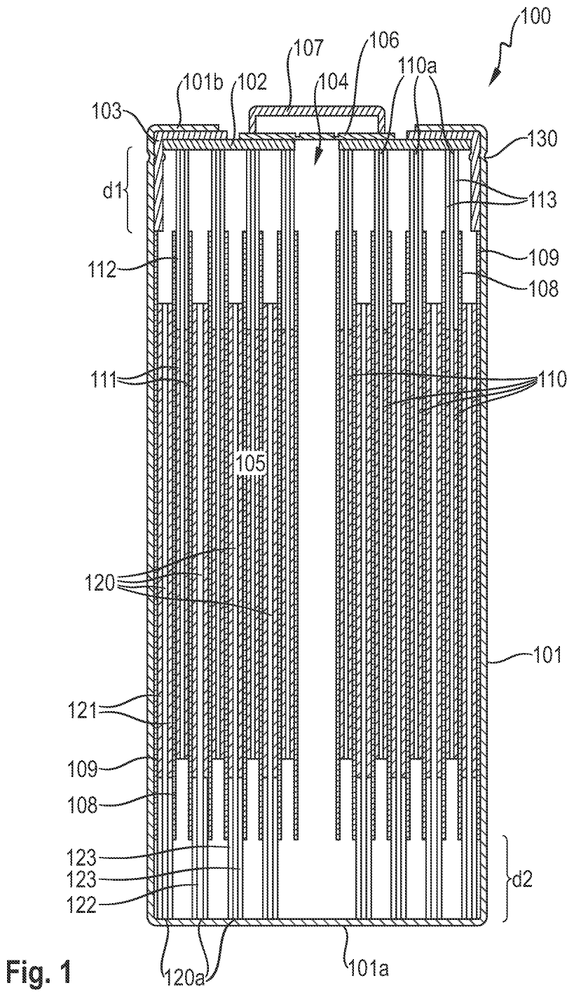

The energy storage cell 100 shown in longitudinal section in FIG. 1 is constructed as a cylindrical round cell of a so-called contact plate design and represents a possible example of an electrochemical energy storage element that can be manufactured using our process. The energy storage cell 100 comprises a cup-shaped metallic housing part 101 with a disc-shaped bottom 101a and a circular opening (defined by the rim 101b) in the upper region. The metallic housing part 101 is in particular a cup-shaped deep-drawn part. In the closed or fully assembled form of the energy storage cell 100 shown here, the rim 101b is bent radially inward at a right angle to close the housing. The upper closure of the housing is formed by a disc-shaped contact element (contact plate) 102 having a central hole 104. The central hole 104 is closed by the metal disk 106 with a pole cap 107 arranged thereon. A seal 103 is provided between the outer edge of the contact plate 102 and the upper edge 101b of the cup-shaped, metal housing part 101. The inwardly bent upper edge 101b of the cup-shaped, metallic housing part 101 thereby embraces the seal 103 and the outer edge of the contact plate 102.

The metallic housing part 101, together with the contact plate 102, encloses an inner space in which the electrode-separator assembly 105, which is formed as a winding, is axially aligned. The hole 104 in the contact plate 102 is provided to fill the electrolyte into the housing of the energy storage cell 100 during the manufacturing process, before the hole 104 is closed with a metal disc (sheet metal disc) 106. When assembled, the hole 104 is sealed by the metal disc 106. The metal disc 106 may have one or more elongated recesses as predetermined breaking points so that the metal disc 106 may serve as a pressure relief valve.

The electrode-separator assembly 105 is in the form of a cylindrical winding with two end faces, between which the circumferential winding shell extends, which rests against the circumferential inner side of the cup-shaped, metallic housing part 101. The electrode-separator assembly 105 is formed of a positive electrode and a negative electrode, and separators 108 and 109 interposed therebetween, each of which is formed in a belt shape and wound in a spiral shape. The end faces of the electrode-separator assembly 105 are formed by the longitudinal edges of the separators 108 and 109. In the center of the winding or of the electrode-separator assembly 105, there may be a central cavity and/or a winding core.

Current collectors 110 and 120 protrude from the end faces of the electrode-separator assembly 105. The corresponding protrusions are labeled d1 and d2. The cathode current collector 110 emerges from the upper end face of the electrode-separator assembly 105. The anode current collector 120 emerges from the lower end face. The cathode current collector 110 is loaded with a layer of a positive electrode material 111 in a band-shaped main region. The anode current collector 120 is loaded with a layer of a negative electrode material 121 in a band-shaped main region. The cathode current collector 110 has an edge strip 112 extending along the upper longitudinal edge 110a of the cathode current collector 110, which is not loaded with the positive electrode material 111. Instead, a coating 113 of a ceramic support material is applied here to stabilize the current collector 110 in this area. The anode current collector 120 has an edge strip 122 extending along the lower longitudinal edge 120a of the anode current collector 120, which is not loaded with the negative electrode material 121. Instead, a coating 123 of a ceramic support material is also applied to this area.

The upper edge 110a of the cathode current collector 110 is in direct contact with the disk-shaped contact element (contact plate) 102 over its entire length and is connected to the latter at least over several sections, preferably over its entire length, for example, by welding (in particular with the aid of a laser). The contact element 102 thus serves simultaneously for electrical contacting of the cathode and as a housing cover.

The lower edge 120a of the anode current collector 120 is in direct contact with the bottom 101a of the cup-shaped, metallic housing part 101 over its entire length and is connected to the latter at least over several sections, preferably over its entire length, for example, by welding (in particular with the aid of a laser). The bottom 101a of the cup-shaped, metallic housing part 101 thus serves not only as part of the housing, but also for electrical contacting of the anode.

The seal 103 between the upper edge 101b of the cup-shaped, metallic housing part 101 and the terminating disk-shaped contact element 102 electrically insulates the parts from each other. The edge 101b of the cup-shaped, metallic housing part 101 is bent radially inwards over the edge of the contact element 102 enclosed by the seal 103 and fixes the contact element 102 in the circular opening of the cup-shaped, metallic housing part 101. Below the bend of the upper edge 101b of the cup-shaped, metallic housing part 101 there is a circumferential bead 130 which stabilizes the arrangement.

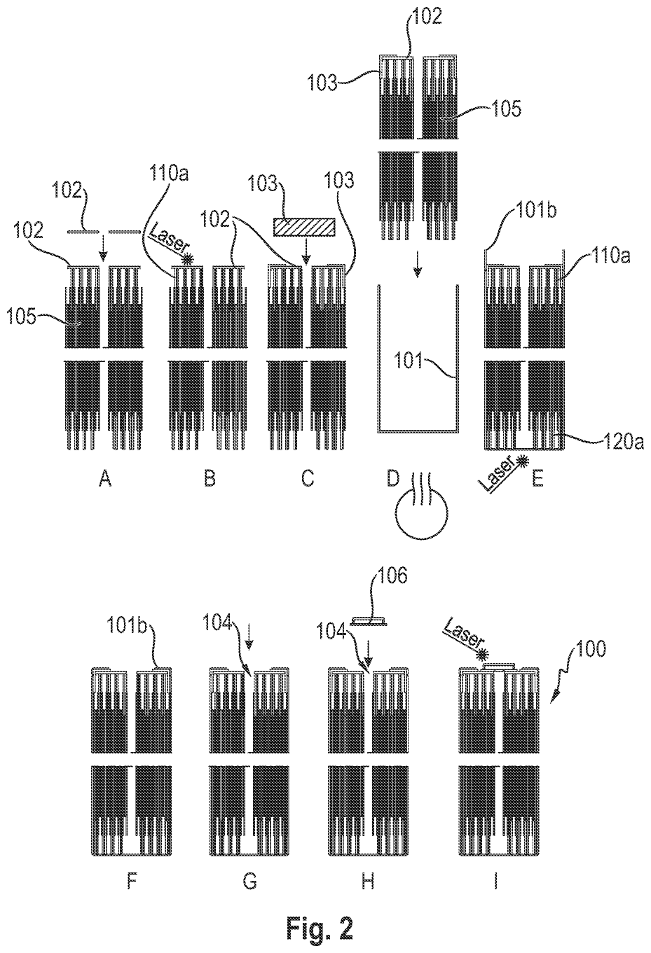

FIG. 2 illustrates the various steps A to I in the manufacture of such an energy storage cell 100 formed as a cylindrical round cell in contact plate design. First, in step A, the electrode-separator assembly 105 is provided, and the disk-shaped contact element (contact plate) 102 is placed on its upper end face.

In step B, the contact element 102 is welded to the electrode-separator assembly 105 in the region of its upper projecting longitudinal edge 110a of the cathode current collector.

In step C, the circumferential seal 103 is applied to the edge of the disk-shaped contact element 102.

As an important feature of our method, heating of the metallic housing part 101 takes place in step D before the electrode-separator assembly 105 is inserted into the metallic housing part. Due to the heating, a thermal expansion of the housing part 101 is achieved. The thermal expansion increases the opening width of the metallic housing part 101 so that, on the one hand, insertion of the electrode-separator assembly 105 is facilitated. On the other hand, by this mea-sure, an electrode-separator assembly 105 having a larger outer circumference compared with conventional manufacturing methods can be used. Thus, on the one hand, the internal volume of the metallic housing part 101 can be fully utilized and an increase in the capacity of the energy storage cell is achieved and the energy density is controlled. For example, the volume gain for the dimensions of the electrode-separator assembly 105 can amount to almost an entire additional winding in a winding-shaped electrode-separator assembly, especially in very thin electrodes. The additional winding in the outer region of the winding provides a large gain in electrode length and thus a significant increase in capacitance. On the other hand, the controlled volume utilization achieves stabilizing effects, particularly with regard to spatial expansion of the electrodes during the charging process and the associated mechanical stress on the electrodes, and with regard to avoiding possible vibrations within the housing of the energy storage cell.

The heating in step D preferably takes place in two phases, namely a preheating phase and a subsequent high-temperature phase. In the preheating phase, the material of the metallic housing part 101 is first brought to a temperature of approximately 50 to 60° C., for example. Advantageously, the waste heat of another process can be used for this purpose. This preheating phase can already be carried out in a negative pressure atmosphere and/or under dehumidifying conditions so that any residual moisture still present inside the metallic housing part 101 is removed. Just before the electrode-separator assembly 105 is inserted into the metallic housing part 101, the high-temperature phase takes place, and the metallic housing part 101 is heated, for example, to a temperature of about 100° C. During this high-temperature phase, the desired opening width of the metallic housing part 101 is achieved so that the electrode-separator assembly 105 can be inserted.

For example, a common metallic housing part 101 for a cylindrical round cell with a form factor of 21×70 (standard 21700) has an internal dimension of approx. 20.6 mm in the area of the opening at 20° C. At 100° C., i.e., 80 K difference, an inner diameter of greater than 20.8 mm is achieved for a metallic housing part 101 made of nickel-plated steel. Therefore, in this example, the method can be used to introduce a wound electrode-separator assembly 105 having a maximum outer diameter of 20.6 mm.

A difference of 0.2 mm between the inner circumference of the metallic housing part 101 expanded by heating and the maximum outer circumference of the electrode-separator assembly 105 (in the uncharged state) has generally proved to be particularly suitable, since a difference of 0.2 mm represents a compromise between volume loss and the force to be applied for the insertion. If the difference falls below 0.2 mm, for example, a difference of only 0.1 mm, the insertion force is generally borderline high. Even though the insertion force can be reduced by a negative pressure atmosphere, it is generally advantageous to maintain a difference of 0.2 mm also in terms of a suitable process speed in an automated assembly process. Maintaining the difference of 0.2 mm between the outer circumference of the electrode-separator assembly 105 and the inner circumference of the housing further ensures that damage to the electrode-separator assembly does not occur during insertion into the housing part 101.

Insertion of the electrode-separator assembly 105 into the metallic housing part 101 is also preferably still carried out under a negative pressure atmosphere to remove any residual moisture that may still be present, in addition to the controlled process speed, and to slow down the cooling process so that gentle material treatment is ensured.

When the electrode-separator assembly 105 is inserted into the cup-shaped metallic housing part 101, the electrode-separator assembly 105 is inserted until the longitudinal edge 120a of the anode current collector projecting from the electrode-separator assembly at the bottom is in direct contact with the bottom of the cup-shaped metallic housing part 101.

In step E, the longitudinal edge 120a of the anode current collector is welded to the bottom of the cup-shaped metallic housing part 101.

In step F, the opening edge 101b of the cup-shaped metallic housing part 101 is bent radially inward.

In step G, the housing is filled with electrolyte, which is metered into the housing through opening 104.

Then, in step H, the metal disk 106 with the pole cover arranged thereon is placed on the opening 104 and fixed by laser welding in step I so that the housing is closed and thus the energy storage cell 100 is completed.

The working example explained on the basis of FIGS. 1 and 2 shows a special design of a cylindrical round cell with the so-called contact plate design. In a corresponding manner, our process is also applicable for the manufacture of other energy storage cells. A prerequisite for the applicability of our process is the use of a metallic housing or a metallic housing part into which an electrode-separator assembly is introduced. In this respect, our process can advantageously be used in principle for all energy storage cells with a metallic housing. This therefore applies to cylindrical round cells and button cells as well as prismatic cells.

1-13. (canceled)

14. A method of manufacturing an electrochemical energy storage element, the energy storage element comprising a housing having at least one metallic housing part and an electrode-separator assembly disposed inside the housing, the method comprising:
a. providing the metallic housing part and the electrode-separator assembly,
b. heating the metallic housing part to cause expansion of the housing part,
c. inserting the electrode-separator assembly into the expanded metallic housing part, and
d. closing the metallic housing part to form the housing.

15. The method of claim 14, wherein:
a. the heating of the metallic housing part according to b. is performed by an input of electrical energy, an input of inductive and/or ohmic energy.

16. The method of claim 14, wherein at least one of:
a. heating the metallic housing part according to step b. comprises a high temperature phase, and
b. in the high-temperature phase, the metallic housing part is heated at least in some areas to a temperature of 80 to 150° C.

17. The method of claim 14, wherein at least one of:
a. heating the metallic housing part according to b. comprises a preheating phase, and
b. in the preheating phase, the metallic housing part is heated to a temperature of 35 to 80° C.

18. The method of claim 17, wherein:
a. the temperature of the metallic housing part in the preheating phase is brought about with waste heat.

19. The method of claim 14, wherein:
a. the metallic housing part is cooled after inserting the electrode-separator assembly, and
b. the metallic housing part is cooled before the housing is closed.

20. The method of claim 14, wherein:
a. prior to inserting the electrode-separator assembly into the metallic housing part according to c., the electrode-separator assembly is cooled.

21. The method of claim 14, wherein at least one of:
a. at least heating the metallic housing part according to b. is performed under dehumidifying conditions,
b. at least the insertion of the electrode-separator assembly into the metallic housing part according to c. is performed under dehumidifying conditions,
c. at least the heating of the metallic housing part according to b. is performed under negative pressure conditions, and
d. at least the insertion of the electrode-separator assembly into the metallic housing part according to c. is performed under negative pressure conditions.

22. The method of claim 14, wherein one of:
a. the housing of the energy storage element is a cylindrical housing, and
b. the housing of the energy storage element is a prismatic housing.

23. The method of claim 14, wherein one of:
a. the electrode-separator assembly is a winding, and
b. the electrode-separator assembly is a stack.

24. The method of claim 14, wherein:
a. the electrochemical energy storage element is a lithium ion cell or comprises one or more lithium ion cells.

25. An electrochemical energy storage element comprising a housing having at least one metallic housing part and an electrode-separator assembly disposed within the housing, wherein the electrochemical energy storage element is manufactured by the method according to any claim 14.

26. The electrochemical energy storage element of claim 25, wherein:
a. the energy storage element is a cylindrical round cell having a cylindrical housing and having a winding as an electrode-separator assembly, and
b. with respect to a diameter of the cylindrical round cell, the energy storage element has a spatial utilization of the internal volume of the housing by the winding of more than 99%, without taking into account any central cavity of the winding which may be present.
